(19) United States
(12) Patent Application Publication
(10) Pub. No.: US 2008/0080388 A1
(43) Pub. Date: Apr. 3, 2008

(54) Probe response suppression

(75) Inventors: Frederick Dean, Wilmette, IL (US); Huizhao Wang, San Jose, CA (US)

Correspondence Address: Tropos Networks, PO Box 641867, San Jose, CA, 95164-1867, US

(73) Assignee: Tropos Networks Inc.

(21) Appl. No.: 11/541,816

(22) Filed: Oct. 2, 2006

(51) Int. Cl. H04J 1/16

(52) U.S. Cl. 370/252; 370/392

(57) ABSTRACT

An apparatus and method of an access point suppressing probe responses is disclosed. The method includes the access point receiving a probe request from a client device. The access point determines a quality of a link between the access point and the client device based on the probe request, and the access point communicates to other access points, a client identifier and the quality of the link between the access point and the client device.

### FIELD OF THE INVENTION

The invention relates generally to wireless communications. More particularly, the invention relates to a method and apparatus of suppressing the number of probe responses of a wireless network in response to a wireless client device probe request.

### BACKGROUND OF THE INVENTION

FIG. 1 shows a prior art wireless network that includes access points 120, 122, 124, 126. The access points 120, 122, 124, 126 are wire connected to a wired network 110, which can be connected to the internet 100. A client device 150 initiates a wireless connection to one of the access points 120, 122, 124, 126 by broadcasting a probe request. As shown, the probe request can be received by multiple access points 120, 122, 124, 126. The access points that receive the probe request respond with a probe response. Based on the probe responses, the client device selects one of the access points to associate with, providing the client device 150 with wireless access to the wireless network 110.

If the client device 150 is located proximate to many access points, the client device 150 can receive many probe responses. In addition to adding data traffic to the available transmission channel, the existence of many probe response can confuse the client device 150. Additionally, wireless connections are subject to environmental conditions that make the connections less reliable than wired connections. As a result, client devices may not do a very good job at selecting which access point to associate with. That is, the client device may select an access point that provides an inferior wireless connection as compared to another available access point.

The client device may base its selection to some extent upon the signal strengths of probe responses received from the access points. This strength, however, only reflects the quality of the wireless connection directed towards the client device. The strength does not necessarily provide an accurate indication of the quality of the wireless connection directed from the client device to the access point.

It is desirable to have an apparatus and method for supressing probe responses of a wireless network, thereby allowing a client device to improve and maintain access point selections.

### SUMMARY OF THE INVENTION

One embodiment of the invention includes a method of an access point suppressing probe responses, thereby allowing client device to effectively maintain an association with the access point. The method includes the access point receiving a probe request from a client device. The access point determines a quality of a link between the access point and the client device based on the probe request, and the access point communicates to other access points, a client identifier and the quality of the link between the access point and the client device.

Another embodiment of the invention includes a method of determining which of a plurality of access points has a highest quality link with a client device. The method includes at least one of the plurality of access points receiving a probe request from the client device. Each access point that receives the probe request, estimates a link quality between the access point and the client device. Each access point that receives the probe request, broadcasts to other access points, a client device identifier and the corresponding link quality.

Another embodiment of the invention includes a method of an access node within a wireless mesh network suppressing client responses. The method includes the access node receiving a probe request from a client device. The access node determines a quality of a link between the access node and the client device based on the probe request. The access node communicates to other access nodes, a client identifier and the quality of the link between the access node and the client device.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 shows a prior art wireless network that includes several access points.

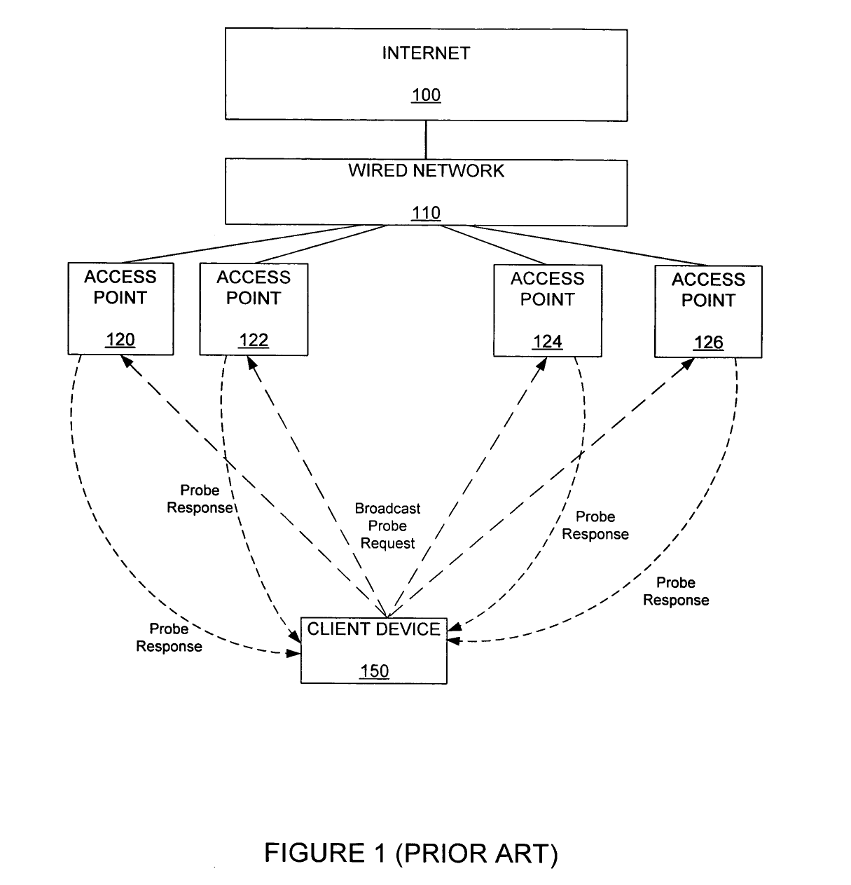

FIG. 2 shows an example of a wireless network that includes access points that perform a comparative link quality analysis and suppresses probe responses.

FIG. 3 is a flow chart that includes steps of one example of a method of suppressing access point probe response.

FIG. 4 shows an example of a wireless mesh network that includes access nodes that perform a comparative link quality analysis and that suppress probe responses.

FIG. 5 is a flow chart that includes steps of one example of a method of a wireless mesh network suppressing access node probe responses.

### DETAILED DESCRIPTION

As shown in the drawings for purposes of illustration, the invention is embodied in an apparatus and method for wireless networks and wireless mesh networks that suppress probe responses. The embodiments disclosed aid, among other things, a client device in maintaining an association with an access point or access node of a wireless network. Maintenance of associations is desirable because it helps prevent client devices from roaming excessively.

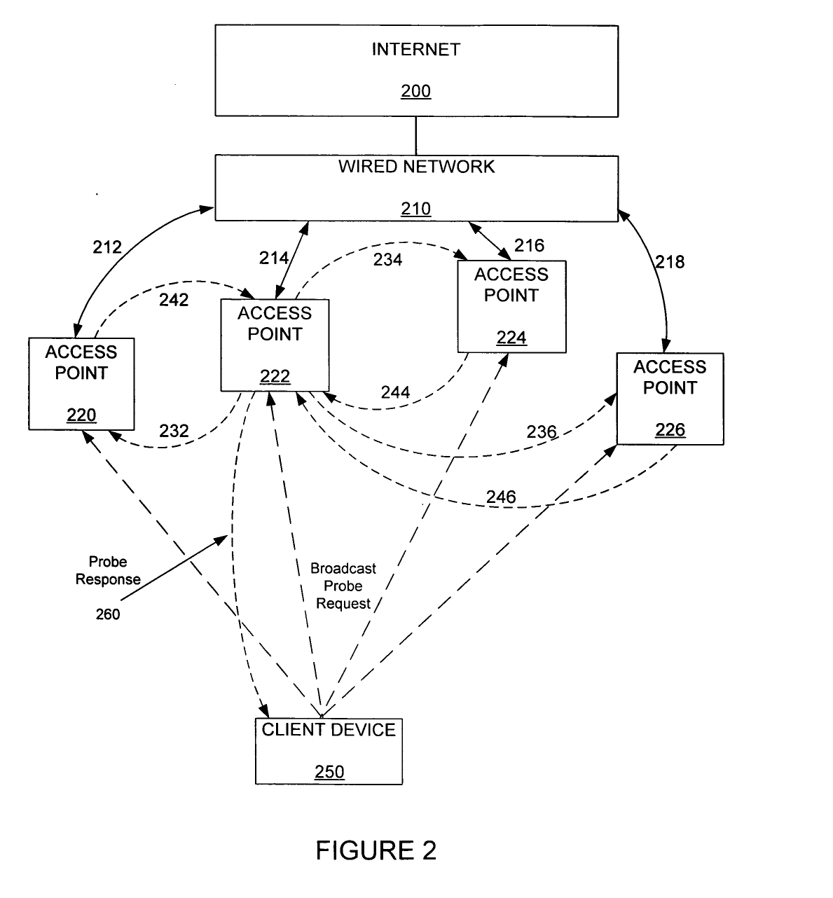

FIG. 2 shows an example of a wireless network that includes access points 220, 222, 224, 226 that perform a comparative link quality analysis and suppresses probe responses. Each access point that receives a probe request, estimates a link quality between the access point and the client device. The receiving access points then share the link quality with neighboring access points enabling the access point with the best link quality to respond to the probe request.

The access points of FIG. 2 can be wired connected through connections 212, 214, 216, 218 to a wired network 210. The wired network 210 can be connected, for example, to the internet 200.

More than one access point, such as, access points 220, 222, 224, 226 receive probe requests from a client device 250. Each access point that receives the probe estimates a quality of the wireless link between the client device 250 and the receiving access point. For each receiving access point, the quality of the link can be determined, for example, by measuring the received signal strength of the probe request. That is, the signal strength of the probe request is to at least some extent dependent upon the quality of the transmission link between the client device transmitting the probe request, and the device receiving the probe request. Generally, the greater the received signal strength, the better the quality of the link between the client device and the receiving device.

Wireless network parameters, however, can also influence the desirability of one network device (gateways, access node or access point) over another network device. For example, data throughput, latency, backhaul bandwidth and stability of the access point can also be useful in determining which probe request receiving access point should be connected to the probe request transmitting client device. Therefore, the link quality that is communicated from an access point (or access node) can additionally include one or more network parameters associated with the access point. An embodiment includes the link quality (for example, an RSSI measurement) being modified to reflect one or more network quality parameters associated with the access point.

As previously stated, the access points 220, 222, 224, 226 can receive a probe request from the client device 250. Each access point can estimate a link quality between the access point and the client device 250 by measuring, for example, a receive signal strength of the probe request. The link quality can be communicated to the neighboring access points be broadcasting a received signal strength indicator (RSSI) to the neighboring access points. For example, as shown in FIG. 2, the access point 222 broadcasts to the neighboring access point 220 as indicated by the arrow 232, to the neighboring access point 224 as indicated by the arrow 234, and to the neighboring access point 226 as indicated by the arrow 236. The access point 222 receives from the neighboring access point 220 a link quality indicator (the link quality between the access point 220 and the client device 250) as indicated by the arrow 242. The access point 222 receives from the neighboring access point 224 a link quality indicator (the link quality between the access point 224 and the client device 250) as indicated by the arrow 244. The access point 222 receives from the neighboring access point 226 a link quality indicator (the link quality between the access point 226 and the client device 250) as indicated by the arrow 246.

If, for example, the link quality indicator of the access node 222 is determined to be the best, the access node 222 responds to the probe request with a probe response 260. As indicated above, the determination of best link quality can be based on the RSSI as determine by each individual access point. Additionally, the best link quality can also include network quality parameters as previously discussed. The network quality parameters can be communicated directly to the neighboring access point, or the network quality parameters can be used to modify, for example, the RSSI to reflect the quality of the network quality parameters.

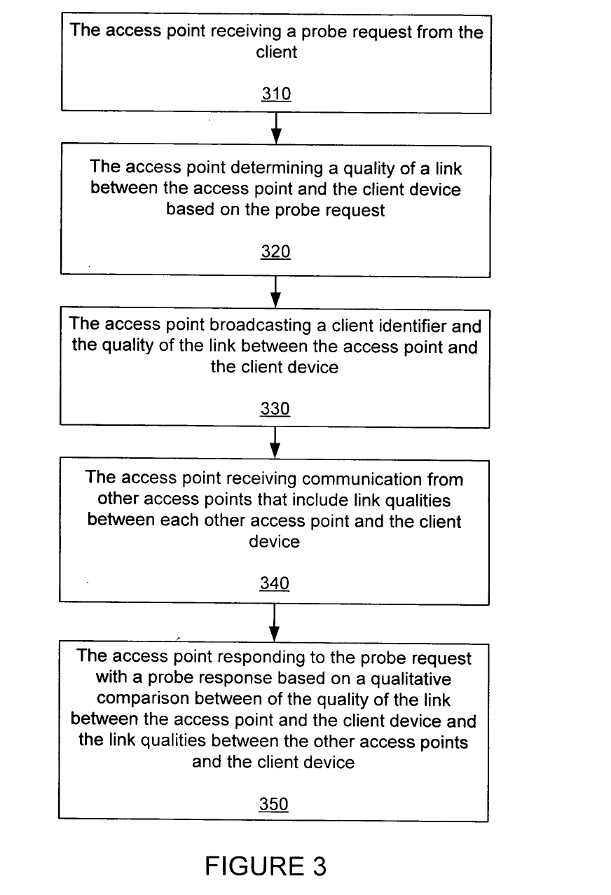

FIG. 3 is a flow chart that includes steps of one example of a method of suppressing access point probe response. A first step 310 includes the access point receiving a probe request from a client device. A second step 320 includes the access point determining a quality of a link between the access point and the client device based on the probe request. A third step 330 includes the access point communicating to other access points, a client identifier and the quality of the link between the access point and the client device.

As previously described, the quality of the link can be determined by a receive signal strength of the probe response. The link quality can be additionally based on a network quality parameter of the access point.

The access point communicates the quality of the link between the access point and the client device. This allows the access points of the network to determine which of the access points has the best link quality. The access point with the best link quality can respond to the probe request. The process allows the client device to make a better selection than if all of the access points were to respond with a probe response. Additionally, the method reduces the number of probe responses, which improves air-time usage of the available transmission channels.

FIG. 3 shows additional steps that can be included to aid the access point in determining if it has the best link quality to the client device. The additional steps include a fourth step 340 that includes the access point receiving communication from other access points that include link qualities between each other access point and the client device. A fifth step 350 includes the access point responding to the probe request with a probe response based on a qualitative comparison between of the quality of the link between the access point and the client device and the link qualities between the other access points and the client device.

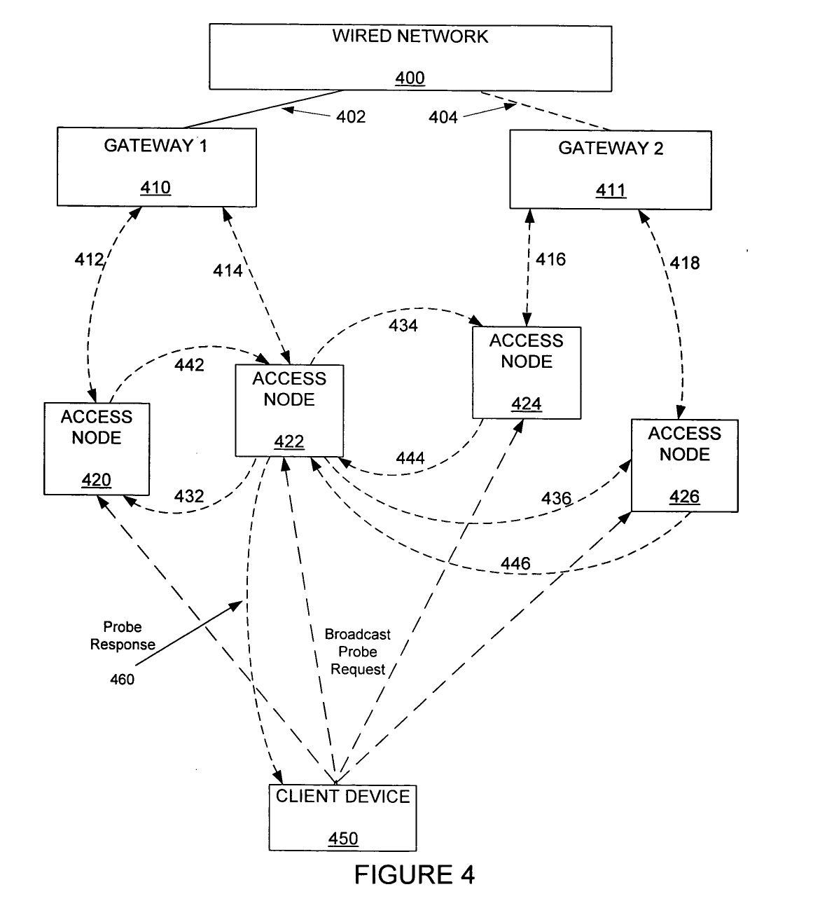

FIG. 4 shows an example of a wireless mesh network that includes access nodes 420, 422, 424, 426 that perform a comparative link quality analysis and suppresses probe responses. The wireless mesh network includes gateways 410, 411 that can be wire or wirelessly connected (connections 402, 404) to a wired network 400, and provide the access nodes 420, 422, 424, 426 with access to the wired network 400. The wired network 400 can be connected, for example, to the internet.

As will be described, the access nodes 420, 422, 424, 426 select route to the gateways 410, 411. As shown in FIG. 4, the access node 420 is wirelessly connected through a link 412 to the gateway 410, the access node 422 is wirelessly connected through a link 414 to the gateway 410, the access node 424 is wirelessly connected through the link 416 to the gateway 411, and the access node 426 is wirelessly connected to through the link 418 to the gateway 411. A default gateway of an access node is the gateway that the access node has select as having the best routing path.

As will be described, the gateways 410, 411 and the access nodes 420, 422, 424, 426 can all provide a client device (such as, client device 450) with wireless access to the wired network 400. The methods of probe response suppression described for access node are applicable for gateways as well. The term “access node” is used here for nodes within a wireless mesh network as opposed to the “access points” of the wireless network of FIG. 2. The terms can be interchanged. The distinction here is between a wireless network and a wireless mesh network.

Initial link quality estimates of the wireless mesh network of FIG. 4 can be made is a similar fashion as the initial link quality estimates of the wireless mesh network of FIG. 2. More specifically, each access node estimates the quality of the wireless link between the access node and the client device by measuring the signal strength of probe requests received from the client device 450. The link quality estimates can also include wireless mesh network quality parameters of the access nodes within the wireless mesh network.

Mesh Network Quality Parameter

One example of a mesh network quality parameter is an indicator of a path quality of the access node to a gateway of the mesh network. As shown in FIG. 4, routing paths exist between access nodes of a mesh network and default gateways. The quality of the paths can vary from access node to access node. The quality of the routing path can influence, for example, the data throughput and latency for data communication between the access node and the gateway. This in turn, effects the data communication of any client that associates with the access node. Therefore, providing the mesh network path quality of each access node within communication between neighboring access nodes allows for a better selection of which access node has the best quality link with a client device.

The path quality can include both an upstream direction path quality (towards the default gateway) and a downstream direction path quality (away from the default gateway). As will be described, the downstream link quality can be determined by a persistence of successfully received routing packets.

Another wireless network quality parameter that can be useful includes an indicator of a bandwidth of a backhaul connection. If the connecting device is a gateway or an access point, the backhaul is typically the connection between the connecting device and the wired network. If the connecting device is an access node, the backhaul is the connection between the default gateway of the access node and the wired network.

Mesh networks can include fixed and mobile access nodes. Mobile access nodes are typically less reliable because of the changing condition of their wireless links (upstream and/or downstream). Therefore, another useful mesh network quality parameter is an indicator of whether the access node is a mobile access node or a fixed access node.

Mesh networks include some form of latency between, for example, an access node of the mesh network and the corresponding default gateway. More specifically, the latency can be for the data path between the access node and its default gateway. The latency can vary form one access node to another. Once the access node knows its latency, it can indicate the latency through the latency indicator, which can be include as or within the mesh network quality parameter.

Routing Selections

As previously described, the quality of an upstream path from an access node to a default gateway can be determined during routing selection by the access node. An embodiment of the mesh network includes gateways originating and broadcasting routing beacons at a predetermined rate (such as 4 beacons per second). Each first level access node (such as access nodes 420, 422, 424, 424) receive routing beacons from at least one of the gateways 410, 411. By knowing the original rate in which the beacons are broadcast from the gateways, and the rate at which routing beacons are successfully received, the receiving access node can determined the persistence of successfully received routing beacons. An embodiment includes each first level access node selecting an upstream gateway based on a persistence of successfully received routing beacons.

Each first level access node can then rebroadcast the successfully received routing beacons. The rebroadcast beacons can include additional information allowing second level access nodes (not shown) that receive the rebroadcast routing beacons to determine a routing path back to a gateway. The additional information can include identification (for example, an address) of the first level access node or a hop count (hop count indicates the number of wireless links an access node is from a gateway).

The mesh network can include any number of gateways and any number of access nodes. The number of wireless hops include within the wireless mesh network is not limited.

As previously stated, the persistence of received routing beacons can be used to select a routing path to a gateway. The persistence reflects that quality of the routing path to a gateway, and can be used to provide routing path quality within probe responses transmitted by each access node.

The routing path quality can be determined in both the downstream direction (away from the default gateway) and the upstream direction (towards the default gateway). The downstream quality can be determined by receiving routing beacons as described. The upstream quality can be determined by an upstream device (access node or gateway) receiving routing beacons from the access node, determining the persistence of successfully received beacons, and then including this information in the beacons that the upstream device broadcasts, and are received by the access node.

More than one access node, such as, access nodes 420, 422, 424, 426 receive probe requests from a client device 450. Each access node that receives the probe estimates a quality of the wireless link between the client device 450 and the receiving access node. For each receiving access node, the quality of the link can be determined, for example, by measuring the received signal strength of the probe request. That is, the signal strength of the probe request is to at least some extent dependent upon the quality of the transmission link between the client device transmitting the probe request, and the device receiving the probe request. Generally, the greater the received signal strength, the better the quality of the link between the client device and the receiving device.

Wireless network parameters, however, can also influence the desirability of one network device (gateway or access node) over another network device. For example, data throughput, latency, backhaul bandwidth and stability of the access node can also be useful in determining which probe request receiving access node should be connected to the probe request transmitting client device. Therefore, the link quality that is communicated from an access node can additionally include one or more network parameters associated with the access node. An embodiment includes the link quality (for example, an RSSI measurement) being modified to reflect one or more network quality parameters associated with the access node. That is, the value of the RSSI can be modified to reflect the quality of the one or more network quality parameters.

As previously stated, the access nodes 420, 422, 424, 426 can receive a probe request from the client device 450. Each access node can estimate a link quality between the access node and the client device 450 by measuring, for example, a receive signal strength of the probe request. The link quality can be communicated to the neighboring access nodes by broadcasting a received signal strength indicator (RSSI) to the neighboring access nodes. For example, as shown in FIG. 4, the access node 422 broadcasts this information to the neighboring access node 420 as indicated by the arrow 432, to the neighboring access node 424 as indicated by the arrow 434, and to the neighboring access node 426 as indicated by the arrow 436. The access node 422 receives from the neighboring access node 420 a link quality indicator (the link quality between the access node 420 and the client device 450) as indicated by the arrow 442. The access node 422 receives from the neighboring access node 424 a link quality indicator (the link quality between the access node 424 and the client device 450) as indicated by the arrow 444. The access node 422 receives from the neighboring access node 426 a link quality indicator (the link quality between the access node 426 and the client device 450) as indicated by the arrow 446. If, for example, the link quality indicator of the access node 422 is determined to be the best, the access node 422 responds to the probe request with a probe response 460.

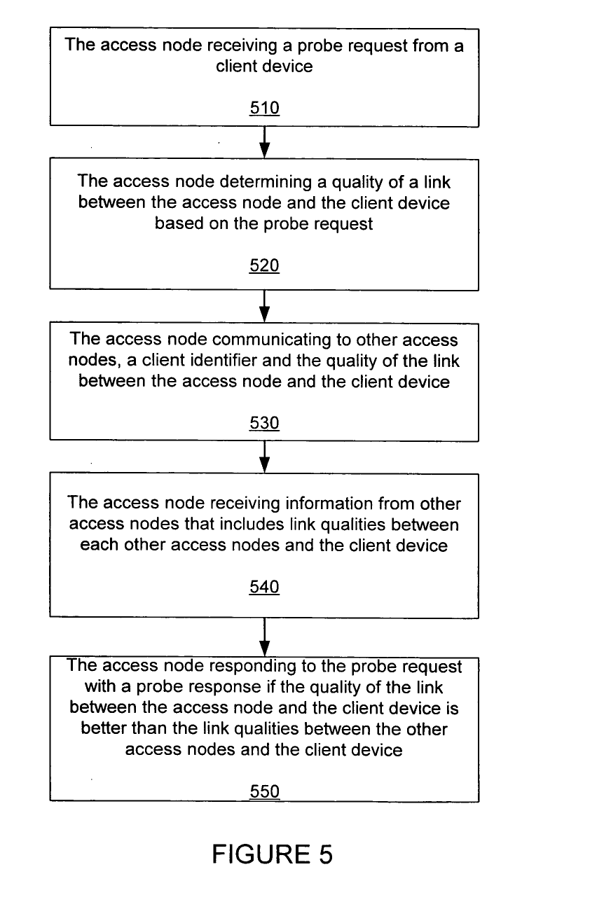

FIG. 5 is a flow chart that includes steps of one example of a method of a wireless mesh network suppressing access node probe responses. A first step 510 includes the access node receiving a probe request from a client device. A second step 520 includes the access node determining a quality of a link between the access node and the client device based on the probe request. A third step 530 includes the access node communicating to other access nodes, a client identifier and the quality of the link between the access node and the client device.

As previously described, the quality of the link between the access node and the client device can be determined based on the probe request by measuring a received signal strength of the probe request. The link quality can be communicated to neighboring access node be transmitting the RSSI of the probe request. Additionally, a wireless mesh network quality parameter can be communicated to the neighboring access nodes. Exemplary wireless mesh network quality parameters include a path quality of the access node to a wireless mesh network gateway, a latency of the access node, and/or a backhaul bandwidth of the access node.

FIG. 5 shows additional steps that can be included to aid the access node in determining if it has the best link quality to the client device. The additional steps include a fourth step 540 that includes the access node receiving information from other access nodes that includes link qualities between each other access nodes and the client device. A fifth step 550 includes the access node responding to the probe request with a probe response if the quality of the link between the access node and the client device is better than the link qualities between the other access nodes and the client device.

Each access node of a wireless network that operating as described, ensures that the proper probe request receiving access node responds to the probe request of the client device. Transmission channel air-time usage is minimized because only a single access node responds to the probe request.

The communication between access nodes can be directly between the access nodes, or the communication can be routed through the gateways of the wireless mesh network.

Although specific embodiments of the invention have been described and illustrated, the invention is not to be limited to the specific forms or arrangements of parts so described and illustrated. The invention is limited only by the appended claims.

What is claimed:

1. A method of an access point suppressing probe responses, comprising:
the access point receiving a probe request from a client device;
the access point determining a quality of a link between the access point and the client device based on the probe request;
the access point communicating to other access points, a client identifier and the quality of the link between the access point and the client device.

2. The method of claim 1, wherein the access point communicates the client identifier and the quality of the link between the access point and the client device, if the quality of the link is above a threshold.

3. The method of claim 1, wherein the access point communicates to the other access points by broadcasting to the other access points.

4. The method of claim 1, further comprising:
the access point determining link qualities between the access point and a plurality of client devices;
the access point broadcasting to other access points, client device identifiers for each of the client devices and corresponding link qualities for each of the client devices, if the corresponding link qualities are above a threshold.

5. The method of claim 1, further comprising:
the access point receiving communication from other access points that include link qualities between each other access point and the client device;
the access point responding to the probe request with a probe response based on a qualitative comparison between of the quality of the link between the access point and the client device and the link qualities between the other access points and the client device.

6. The method of claim 1, wherein determining a quality of a link between the access point and the client device based on the probe request comprises measuring received signal strength of the probe request.

7. The method of claim 1, wherein determining a quality of a link between the access point and the client device is additionally influenced by a wireless network access point quality parameter.

8. The method of claim 7, wherein the network quality parameter comprises at least one of an access point throughput, an access point latency, an access point backhaul bandwidth.

9. A method of determining which of a plurality of access points has a highest quality link with a client device, comprising:
at least one of the plurality of access points receiving a probe request from the client device;
each access point that receives the probe request, estimating a link quality between the access point and the client device;
each access point that receives the probe request, broadcasting to other access points, a client device identifier and the corresponding link quality.

10. The method of claim 9, wherein each access point that receives the probe request, broadcasts the client device identifier and the corresponding link quality if the corresponding link quality is above a threshold.

11. The method of claim 9, wherein the link quality is estimated by a received signal received signal strength at the access point.

12. The method of claim 9, further comprising:
at least one access point receiving a broadcast from an other access point the broadcast including link quality information, and associating with the client device if the link quality between the access point and the client device is better than the link quality of the other access point.

13. A method of an access node within a wireless mesh network suppressing client responses, comprising:
the access node receiving a probe request from a client device;
the access node determining a quality of a link between the access node and the client device based on the probe request;
the access node communicating to other access nodes, a client identifier and the quality of the link between the access node and the client device.

14. The method of claim 13, wherein determining a quality of a link between the access point and the client device based on the probe request comprises measuring received signal strength of the probe request.

15. The method of claim 13, further comprising the access node communicating to other access nodes, network quality parameters of the access node.

16. The method of claim 15, wherein the network quality parameter of the access node comprises at least one of a path quality of the access node to a wireless mesh network gateway, a latency of the access node, a backhaul bandwidth of the access node.

17. The method of claim 13, wherein the access point communicates to the other access points by broadcasting to neighboring access points.

18. The method of claim 13, further comprising:
the access node receiving information from other access nodes that includes link qualities between each other access nodes and the client device;
the access node responding to the probe request with a probe response if the quality of the link between the access node and the client device is better than the link qualities between the other access nodes and the client device.

19. The method of claim 13, further comprising:
the access node receiving information from other access nodes that includes wireless mesh network quality parameters of the other access nodes;
the access point responding to the probe request with a probe response if a combination of the quality of the link between the access point and the client device and the network quality parameter of the access node, is better than a combination of the link qualities between the other access points and the client device and the network quality parameters of the other access nodes.

20. The method of claim 19, wherein the network quality parameter of the other access nodes comprises at least one of a path quality of each of the other access nodes to a wireless mesh network gateway, a latency of each of the other access nodes, a backhaul bandwidth of each of other access nodes.
